(19) United States
(12) Patent Application Publication
(10) Pub. No.: US 2002/0110049 A1
(43) Pub. Date: Aug. 15, 2002

(54) Timepiece with time-display and skin-stimulation control circuit means

(76) Inventor: Wu-Shiung Ting, Keelung (TW)

Correspondence Address: BACON & THOMAS, 4th Floor, 625 Slaters Lane, Alexandria, VA, 22314, US

(21) Appl. No.: 09/779,517

(22) Filed: Feb. 9, 2001

(51) Int. Cl. G04B 47/00

(52) U.S. Cl. 368/10

(57) ABSTRACT

A timepiece comprising time setting and adjustment function control buttons installed in a casing thereof, a time display and skin-stimulation control circuit installed in the casing, a battery installed in the casing and connected to the time-display and skin-stimulation control circuit to provide the time-display and skin-stimulation control circuit with the necessary working voltage, and a plurality of main metal contact elements disposed outside the casing and respectively connected to two opposite terminals of the time-display and skin-stimulation control circuit assembly for contacting the user's skin to output pulse signals to the user's skin from the time-display and skin-stimulation control circuit to stimulate the circulation of blood at a predetermined time interval set through the time setting and adjustment function control buttons.

### BACKGROUND OF THE INVENTION

The present invention relates to a timepiece and, more particularly, to a timepiece with time-display and skin-stimulation control circuit means, which outputs long and/or short pulse signal to the user's skin to report the time under a muted mode and to simultaneously stimulate the circulation of blood.

Regular electronic wristwatches commonly use a voice circuit to report the time, or to give an alarm signal. An electronic wristwatch with voice circuit to report the time is not useful to a person who cannot see and hear. Further, after a long time in sitting or working, one may feel uncomfortable and have to take an exercise or massage to relax the muscles and the joints of the body. It is desirable to have a timepiece that reports the time by stimulating the user's skin with short and long pulse signals and stimulates the circulation of blood when reporting the time.

### SUMMARY OF THE INVENTION

It is the main object of the present invention provides a timepiece that reports the time by stimulating the user's skin with short and long pulse signals and stimulates the circulation of blood when reporting the time. According to one aspect of the present invention, the timepiece comprises a casing, a time setting and adjustment function control buttons installed in the casing, a time display and skin-stimulation control circuit installed in the casing, a battery installed in the casing and connected to the time-display and skin-stimulation control circuit to provide the time-display and skin-stimulation control circuit with the necessary working voltage, and a plurality of main metal contact elements disposed outside the casing and respectively connected to two opposite terminals of the time-display and skin-stimulation control circuit assembly for contacting the user's skin to output pulse signals to the user's skin from the time-display and skin-stimulation control circuit to stimulate the circulation of blood at a predetermined time interval set through the time setting and adjustment function control buttons. According to another aspect of the present invention, the pulse signals include long pulse signal for hour and short pulse signal for minute, so that the time-display and skin-stimulation control circuit reports the time under a muted mode. According to still another aspect of the present invention, the user can operate the time setting and adjustment function control buttons to imperatively drive the time-display and skin-stimulation control circuit to output pulse signals through the user's skin to stimulate the circulation of blood.

### BRIFF DESCRIPTION OF THE DRAWINGS

FIG. 1 is an elevational view of a timepiece constructed according to the present invention.

FIG. 2 is an exploded view of the timepiece shown in FIG. 1.

FIG. 3 is a side view in section in an enlarged scale of a part of the present invention.

FIG. 4 is a system block diagram of the time-display and skin-stimulation control circuit assembly according to the present invention.

FIG. 5 is a circuit block diagram of the time-display and skin-stimulation control circuit assembly according to the present invention.

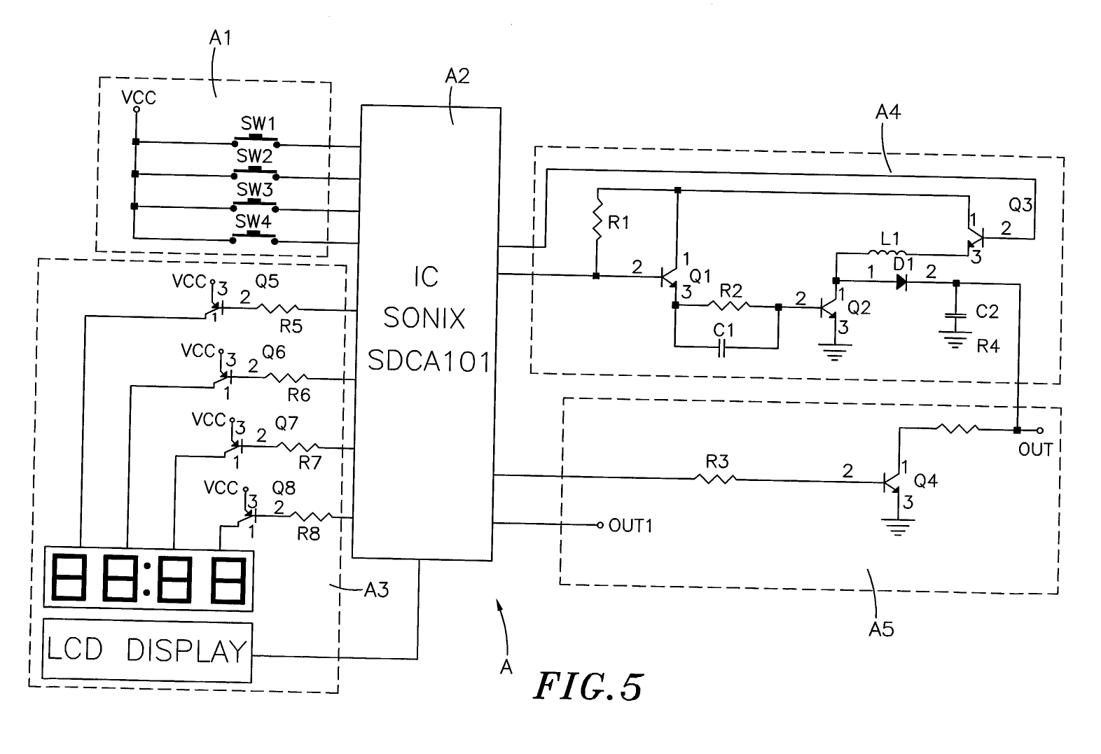

FIG. 6 is an elevational view of an alternate form of the present invention.

### DETAILED DESCRIPTION OF THE PREFERRED EMBODIMENT

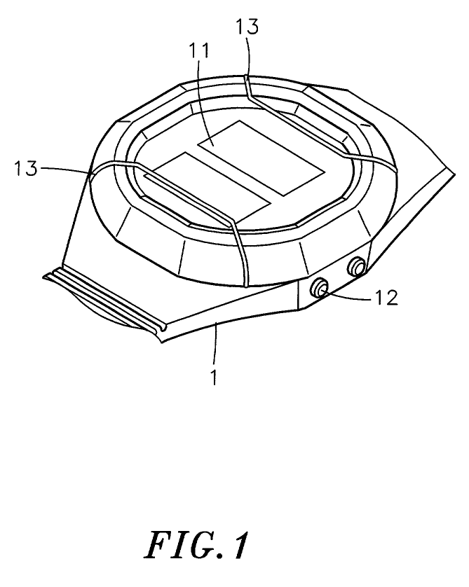

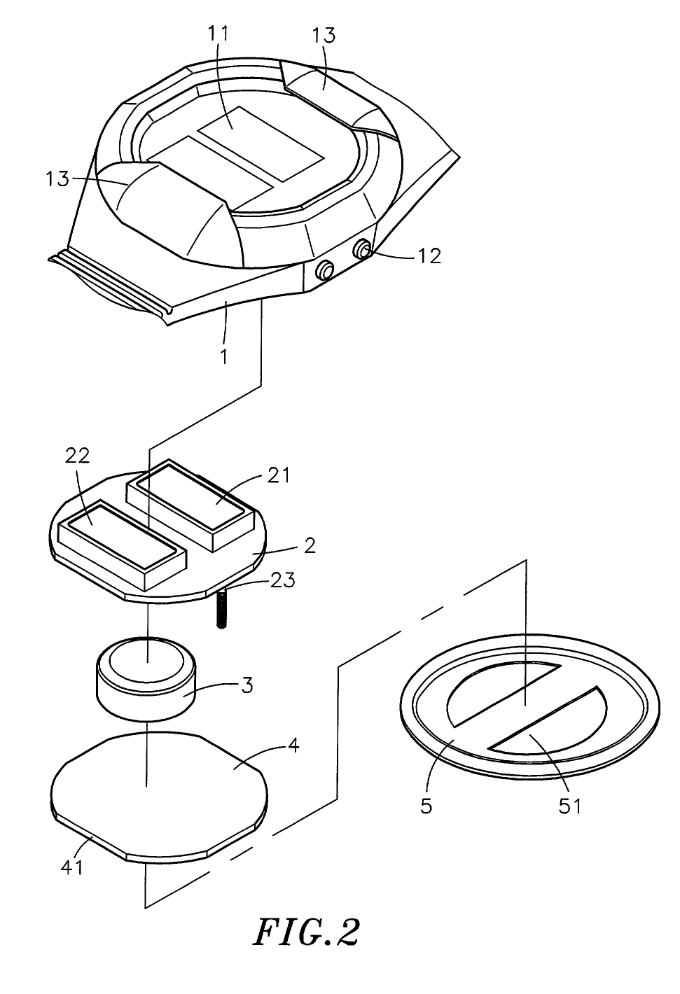

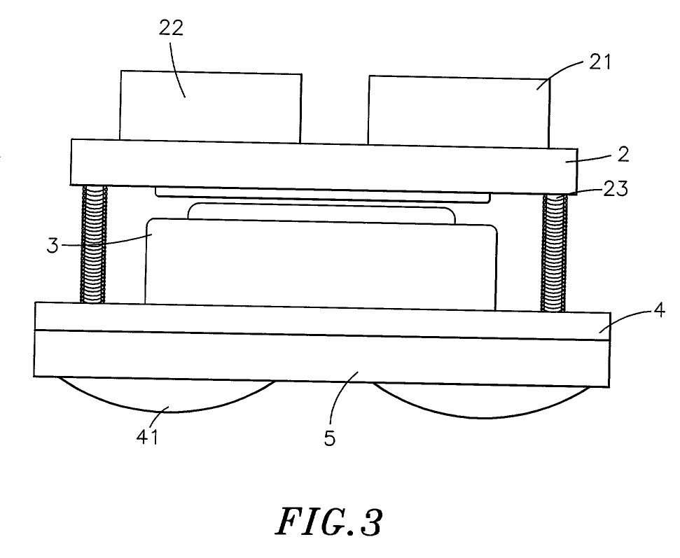

Referring to FIGS. 1, 2 and 3, a timepiece in accordance with the present invention comprises a casing 1 adapted for fastening to the user's wrist, a glass face 11 covered on the casing 1, a set of buttons 12 provided at one side of the casing 1, two first metal contact elements 13 bilaterally disposed at the top of the casing 1, a circuit board 2 mounted inside the casing 1, a back cover 5 covered on the bottom side of the casing 1, the back cover 5 having two openings 51, an electrically insulative plate 4 mounted inside the casing 1 and disposed between the back cover 5 and the circuit board 2, two second metal contact elements 41 fixedly provided at two opposite lateral sides of the electrically insulative plate 4 and respectively extended out of the openings 51 of the back cover 5, and a battery cell 3 mounted inside the casing 1 and disposed between the circuit board 2 and the electrically insulative plate 4. The circuit board 2 comprises a LCD (liquid crystal display) 21 and a 7-segment display 22 disposed at the top and facing the glass face 11 for function display and time display respectively. and two bottom metal spring rods 23 respectively connected between the first metal contact elements 13 and the second metal contact elements 41.

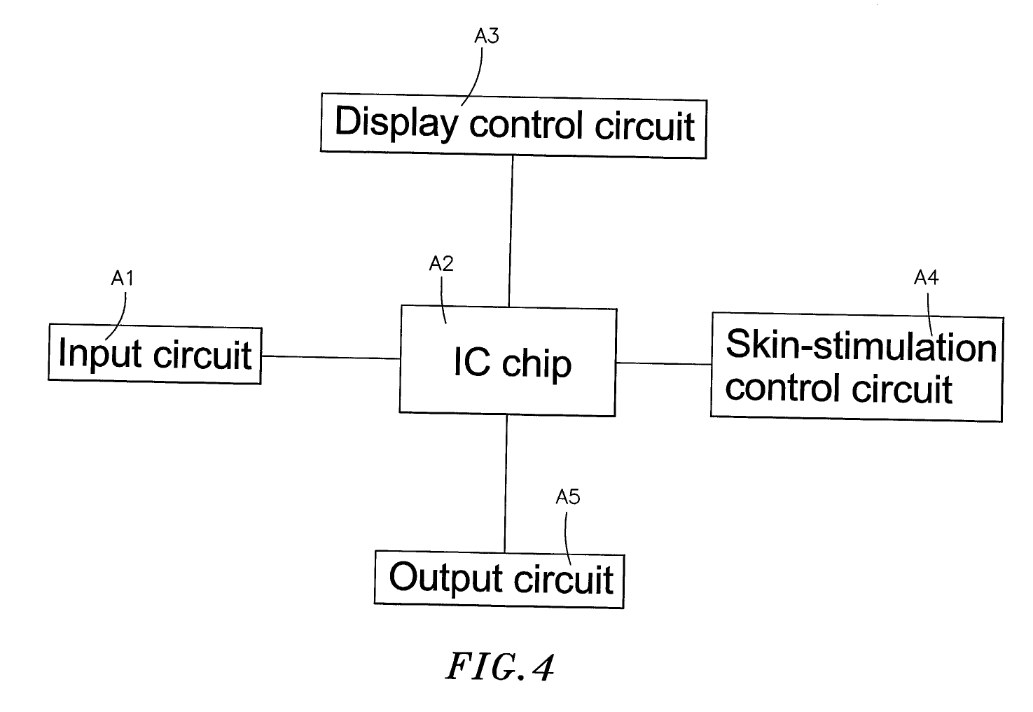

Referring to FIGS. 4 and 3 and FIGS. 1 and 2 again, the buttons 12 are provided for time setting and adjustment controls. The circuit board 2 further comprises a time-display and skin-stimulation control circuit assembly A. The control circuit assembly A comprises an input circuit A1, an IC chip (for example, IC SONIX SDCA101) A2, a display control circuit A3, a skin-stimulation control circuit A4, and an output circuit A5. The input circuit Al receives battery power supply from the battery cell 3. The display control circuit A3 and the skin-stimulation control circuit A4 are respectively connected to the IC chip A2. The skin-stimulation control circuit A4 controls output of pulse signal to the output circuit A5. When the IC chip A2 receives a time triggering signal from the movement of the timepiece at a predetermined time interval or a signal from one button 12, it drives the skin stimulation control circuit A4 to provide a pulse signal to the output circuit A5, causing the output circuit A5 to form with the metal contact elements 13 and 41 and the body of the user an intermittently electrically conductive loop. The pulse signal from the IC chip A2 includes long pulse signal, for example, hour pulse signal, and short pulse signal, for example, minute pulse signal. During operation, the metal contact elements 13 or 41 are maintained in close contact with the skin of the user's body, and the IC chip A2 drives the skin-stimulation control circuit A4 to provide a pulse signal through the skin of the user's body via the metal contact elements 13 or 41 intermittently subject to the set time interval, so as to stimulate the circulation of blood.

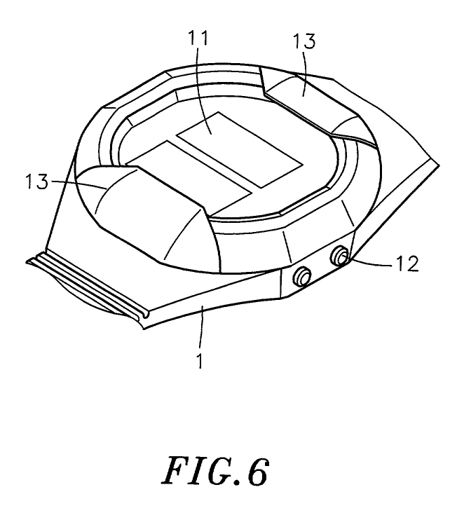

The first metal contact elements 13 can be metal wire members as shown in FIG. 1, or metal sheet members as shown in FIG. 6.

While only one embodiment of the present invention has been shown and described, it will be understood that various modifications and changes could be made thereunto without departing the spirit and scope of the invention disclosed.

What the invention claimed is:

1. A timepiece comprising time setting and adjustment function control buttons installed in a casing thereof, a time display and skin-stimulation control circuit installed in said casing, a battery installed in said casing and connected to said time-display and skin-stimulation control circuit to provide said time-display and skin-stimulation control circuit with the necessary working voltage, and a plurality of main metal contact elements disposed outside said casing and respectively connected to two opposite terminals of said time-display and skin-stimulation control circuit assembly for contacting the user's skin to output pulse signals to the user's skin from said time-display and skin-stimulation control circuit to stimulate the circulation of blood at a predetermined time interval set through said time setting and adjustment function control buttons.

2. The timepiece of claim 1 wherein said main metal contact elements are disposed at a backside of said casing.

3. The timepiece of claim 1 wherein said main metal contact elements are disposed at a front side of said casing.

4. The timepiece of claim 1 wherein said time-display and skin-stimulation control circuit comprises a 7-segment display for time display.

5. The timepiece of claim 1 wherein said time-display and skin-stimulation control circuit comprises a liquid crystal display for the display of function setting.

6. The timepiece of claim 1 wherein said time-display and skin-stimulation control circuit comprises an IC chip, an input circuit, which connects said battery to said IC chip, an output circuit connected to said metal contact elements, and a stimulating control circuit controlled by said IC chip to provide a pulse signal to the user's skin through said output circuit and said metal contact elements subject to a time triggering signal set through said time setting and adjustment function control buttons.

7. The timepiece of claim 2 further comprising a glass face covered on said casing at a front side over said time-display and skin-stimulation control circuit, a back cover covered on said casing at a back side, said back cover comprising two openings, an electrically insulative plate mounted inside said casing and disposed between said back cover and said time-display and skin-stimulation control circuit, two second metal contact elements fixedly provided at two opposite lateral sides of said electrically insulative plate in connection with said main metal contact elements and respectively extended out of the openings of said back cover.

8. The timepiece of claim 3 further comprising a glass face covered on said casing at a front side over said time-display and skin-stimulation control circuit, and a back cover covered on said casing at a back side to hold said battery inside said casing below said time-display and skin-stimulation control circuit.
